(19) United States
(12) Patent Application Publication
(10) Pub. No.: US 2010/0092903 A1
(43) Pub. Date: Apr. 15, 2010

(54) TOOTH BONDING PAD WITH WIRE RETAINING PORTIONS AND RELATED METHODS

(75) Inventor: Jefferson Sabilla, Ontario, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/444,066

(22) PCT Filed: Oct. 10, 2007
(86) PCT No.: PCT/US07/80882

§ 371 Date: Dec. 8, 2009

Related U.S. Application Data
(60) Provisional application No. 60/850,624, filed on Oct. 10, 2006.

(51) Int. Cl. A61C 7/16

(52) U.S. Cl. 433/2; 433/9; 433/24

(57) ABSTRACT

A tooth bonding pad (22) is configured for orthodontic applications and includes a main body (26) and a ligating structure (24) adjacent to the main body. The ligating structure includes a channel (48) that is configured to receive a corrective device (16) therein and to restrict the corrective device from movement relative to the tooth bonding pad. The ligating structure may, for example, be crimpable or it may take the form of a self-ligating structure. The channel (48) may be substantially closed and may include a cover (80) configured to be coupled to other portions of the ligating structure (53) to thereby partially define the channel. The channel (48) may define a longitudinal axis such that the ligating structure (24) is configured to restrict movement of the corrective device (16) in a direction along the axis. Alternatively or additionally, the ligating structure (53) may be configured to restrict movement of the corrective device (16) in a direction transverse to the axis.

### PRIORITY CLAIM

This application claims the benefit of U.S. Provisional Patent Application Ser. No. 60/850,624, filed Oct. 10, 2006 and entitled “Orthodontic Devices, Implants and Related Apparatus,” the disclosures of which are expressly incorporated by reference herein in their entirety.

### TECHNICAL FIELD

This invention generally relates to orthodontic devices and, more particularly, to devices for coupling to teeth.

### BACKGROUND

Orthodontic apparatus are known that provide corrective orthodontic treatments devoted to improving a patient's occlusion. In conventional orthodontic treatments, an orthodontist or an assistant affixes brackets or the like to the patient's teeth and engages a corrective device such as a wire or a spring into a slot of each bracket. The wire applies corrective forces that coerce the teeth to move into correct positions.

Known procedures to apply corrective forces to teeth may further include fixing the position of the bracket or the like relative to the tooth and fixing the position of the bracket or the like relative to the corrective device. Known brackets and the like are designed such that considerable time and skill may be required to couple the corrective device thereto and the brackets or the like to the teeth.

### SUMMARY

In accordance with one embodiment, a tooth bonding pad is configured for orthodontic uses and includes a main body and a ligating structure adjacent to the main body. The ligating structure includes a channel that is configured to receive a corrective device therein and to restrict the corrective device from movement relative to the tooth bonding pad. The ligating structure may, for example, be crimpable or it may take the form of a self-ligating structure. The channel may be substantially closed and may include a cover configured to be coupled to other portions of the ligating structure to thereby partially define the channel.

The channel may define a longitudinal axis such that the ligating structure is configured to restrict movement of the corrective device in a direction along the axis. Alternatively or additionally, the ligating structure may be configured to restrict movement of the corrective device in a direction transverse to the axis.

In another embodiment, an orthodontic assembly includes a corrective device having an elongate portion and a tooth bonding pad. The tooth bonding pad is configured for coupling to a tooth and includes a channel configured to receive the elongate portion therein and to restrict the corrective device from movement relative to the tooth bonding pad. The corrective device may, for example, be one of a group consisting of wires and springs.

The ligating structure may include a main portion and a cover configured for coupling with the main portion such that coupling of the cover to the main portion defines the channel. The channel may define a longitudinal axis, such that coupling of the cover to the main portion restricts movement of the corrective device relative to the tooth bonding pad in a direction along the longitudinal axis.

In another embodiment, an orthodontic assembly includes an orthodontic implant and a corrective device having an elongate portion and being coupled to the orthodontic implant. The assembly also includes a tooth bonding pad that is configured for coupling to a tooth and which includes a channel configured to receive the elongate portion therein and to restrict the corrective device from movement relative to the tooth bonding pad. The orthodontic implant may, for example, be a screw. Examples of orthodontic implants that are contemplated are disclosed in co-pending PCT International application No. ______, filed on Oct. 10, 2007, entitled “Orthodontic Implants,” which is expressly incorporated by reference herein in its entirety. The corrective device may be one of a group consisting of wires and springs.

In yet another embodiment, a tooth bonding pad is configured for orthodontic applications and includes a main body and a ligating structure adjacent the main body. The ligating structure includes a channel defining a longitudinal axis and which is configured to receive a corrective device therein and to restrict the corrective device from movement relative to the tooth bonding pad in a direction along the longitudinal axis and in a direction transverse to the longitudinal axis.

In yet another embodiment, a method of coupling an orthodontic corrective device to a tooth includes coupling a tooth bonding pad to the tooth and inserting an elongate portion of the corrective device through a channel in the tooth bonding pad. The channel is closed around the corrective device to thereby restrict the corrective device from movement relative to the tooth bonding pad. For example, the channel may be closed by coupling a cover of the tooth bonding pad with other portions thereof. The method may include restricting the corrective device from movement in a direction along an axis of the channel. The method may additionally or alternatively include restricting the corrective device from movement in a direction transverse to the axis of the channel. The method may also include crimping a portion of the tooth bonding pad, to thereby lockingly engage the tooth bonding pad and the corrective device relative to one another.

### BRIEF DESCRIPTION OF THE DRAWINGS

Various additional features and aspects will become readily apparent to those of ordinary skill in the art from the following description of illustrative embodiments of the invention and from the drawings in which:

FIG. 1 is a perspective view of an embodiment of an orthodontic system in accordance with the principles of the present invention;

FIG. 2 is a perspective view of a tooth bonding pad and a portion of a wire of the system of FIG. 1;

FIG. 3 is a cross-sectional view taken along line 3-3 of FIG. 2;

FIG. 4 is a perspective view of another embodiment of an orthodontic system in accordance with the principles of the present invention;

FIG. 5 is a perspective view of a tooth bonding pad and a portion of a wire of the system of FIG. 4; and

FIG. 6 is a perspective view similar to that of FIG. 5 showing a cover of the bonding pad decoupled from other portions thereof.

### DETAILED DESCRIPTION

Although the invention will be described next in connection with certain embodiments, the invention is not limited to practice in any one specific type of orthodontic system or device. The description of the embodiments of the invention is intended to cover all alternatives, modifications, and equivalent arrangements as may be included within the spirit and scope of the invention as defined by the appended claims. In particular, those skilled in the art will recognize that the components of the embodiments of the invention described herein could be configured in multiple different ways.

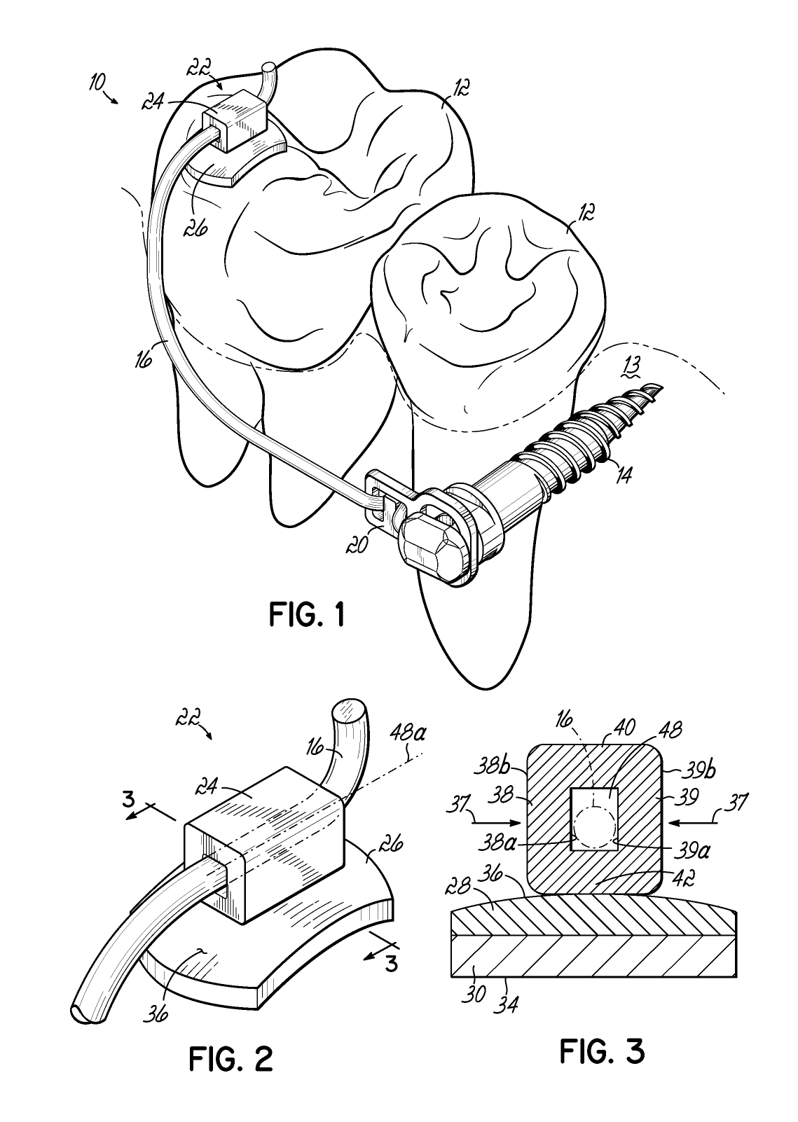

Referring now to the drawings, and more particularly to FIGS. 1-3, an orthodontic system 10 is configured for applying corrective forces to one or more teeth 12. System 10 includes an orthodontic implant in the form of a screw 14, which may be anchored into a supporting structure 13 in a patient's mouth. A corrective device in the form of a wire 16 is coupled to the screw 14 via an eyelet 20 although other types of coupling devices are contemplated. The wire 16 exerts a force on a tooth 12 via a tooth bonding pad 22 to which the wire 16 is coupled. The tooth bonding pad 22 is in turn coupled to the tooth 12. While a corrective device in the form of a wire 16 is depicted, other corrective devices such as springs and other auxiliary devices are similarly contemplated, so long as they have an elongate portion suitable for coupling with tooth bonding pad 22 in ways as described below. The wire 16 is coupled to the tooth bonding pad 22 via a ligating structure in the form of a crimpable tube 24, the details of which are discussed in further detail below.

The tooth bonding pad 22 includes a main body 26 defined by adjacent first and second portions 28, 30 that are integral to one another. The first portion 28 supports the crimpable tube 24 while the second portion 30 includes features permitting attachment to the tooth 12. The second portion 30 includes an outer surface 34 that is shown in FIG. 3 as a flat surface although this is not intended to be limiting but rather merely illustrative. Accordingly, the outer surface 34 may have any suitable shape permitting suitable contact with and attachment to the tooth 12. The tooth bonding pad 22 is attached to the tooth 12, for example, via an adhesive applied at the interface of the tooth 12 with outer surface 34. Those of ordinary skill will readily appreciate that other attachment devices or features may be substituted including but not limited to mechanical and/or chemical devices.

With continued reference to FIGS. 1-3, the first portion 28 of the main body 26 includes a support surface 36 providing a contact and attachment surface for the crimpable tube 24. In this embodiment, the support surface 36 is shown having a convex shape although this could alternatively have any other planar or arcuate shape or any combination thereof. As noted above, a crimpable tube 24 sits on the support surface 36 of first portion 28. In this regard, the crimpable tube 24 may be integrally formed with the first portion 28 or may alternatively be merely coupled thereto. Crimpable tube 24 is configured to receive the wire 16 therethrough and secure or lock the position of the tooth bonding pad 22 relative to the wire 16. To this end, the crimpable tube 24 is a deformable structure such that, when crimped, it frictionally locks (i.e., lockingly engages) the tooth bonding pad 22 and wire 16 to one another. The crimpable tube 24 has a generally square or rectangular cross-section defined by opposed lateral members 38, 39, and opposed end members 40, 42. The lateral and end members 38, 39, 40, and 42 jointly define a channel 48 extending along a longitudinal axis 48a and configured to receive the wire 16 therealong. When the wire 16 is received within the channel 48, the lateral and end members 38, 39, 40, and 42 restrict or at least hinder movement of the wire 16 on the plane of the cross-section shown in FIG. 3 (i.e., in a direction transverse to the longitudinal axis 48a) relative to tooth bonding pad 22.

With continued reference to FIGS. 1-3, the size and shape of the channel 48 are suitably chosen to permit receipt of the wire 16 therethrough. For example, and without limitation, the channel 48 may have a generally square or rectangular shape and be sized such that a distance between lateral walls 38a, 39a respectively of lateral members 38, 39 closely match a diameter or thickness of the wire 16. While the channel 48 is depicted having a square or rectangular shape, other shapes including flat and/or arcuate walls are similarly contemplated.

When a force is exerted, for example, inwardly (toward the wire 16, in the general direction of arrows 37) against outer walls 38b, 39b of the lateral members 38, 39, the crimpable tube 24 is deformed thereby frictionally securing wire 16 against tooth bonding pad 22. More particularly, such deformation moves lateral walls 38a, 39a inwardly such as to mold them about wire 16, which lockingly engages wire 16 from movement relative to crimpable tube 24 (and tooth bonding pad 22) in directions along the longitudinal axis 48a and directions transverse thereto.

While the crimpable tube 24 is shown securing a wire 16 having a round cross-section, those of ordinary skill will readily appreciate that the crimpable tube 24 and, generally, the tooth bonding pad 22 may be used with wires or other corrective devices such as springs having other cross-sectional shapes. Similarly, although not shown, its is contemplated that crimping of crimpable tube 24 may additionally deform wire 16 to further lockingly engage wire 16 and tooth bonding pad 22 to one another.

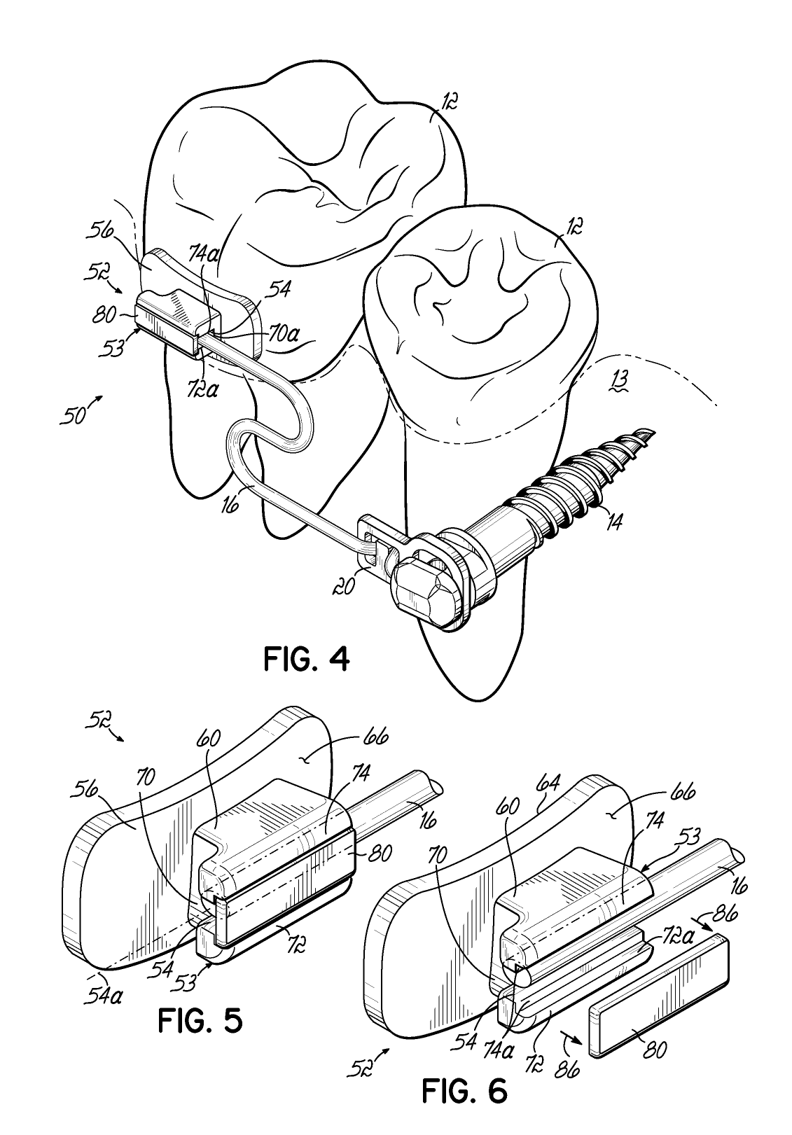

With reference to FIGS. 4-6, in which like reference numerals refer to like features of FIGS. 1-3, an orthodontic system 50 includes an orthodontic implant in the form of a screw 14, which may be anchored into a supporting structure 13 in a patient's mouth. A corrective device in the form of a wire 16 is coupled to the screw 14 via an eyelet 20 although other types of coupling devices are contemplated. The wire 16 exerts a force on a tooth 12 via a tooth bonding pad 52 to which the wire is coupled. The tooth bonding pad 52 is in turn coupled to the tooth 12. While a corrective device in the form of a wire 16 is depicted, other corrective devices such as springs and other auxiliary devices are similarly contemplated, so long as they have an elongate portion suitable for coupling with tooth bonding pad 52 in ways as described below. The wire 16 is coupled to the tooth bonding pad 52 via a ligating structure 53 having a discontinuous channel 54 extending along a longitudinal axis 54a and the details of which are discussed in further detail below.

The tooth bonding pad 52 includes a main body 56 in the form of a generally arcuate plate. The main body 56 supports the ligating structure 53 via a post 60 and includes features permitting attachment to the tooth 12. An outer surface 64 of the main body 56 is shown as a concave surface although this is not intended to be limiting but rather merely illustrative. Accordingly, the outer surface 64 may have any shape permitting suitable contact with and attachment to the tooth 12. The tooth bonding pad 52 is attached to the tooth 12, for example, via an adhesive applied at the interface of the tooth 12 with outer surface 64. Those of ordinary skill will readily appreciate that other attachment devices or features may be substituted including but not limited to mechanical and/or chemical devices.

The main body 56 of the tooth bonding pad 52 includes a support surface 66 providing a contact and attachment surface for the ligating structure 53. In this embodiment, the support surface 66 is shown having a convex shape at least closely matching a shape of the outer surface 64, although this is merely illustrative and not intended to be limiting.

With continued reference to FIGS. 4-6, and as noted above, a ligating structure 53 sits on the support surface 66 of main body 56. In this regard, the ligating structure 53 may be integrally formed with the main body 56 or may alternatively be merely coupled thereto. Ligating structure 53 includes a discontinuous or open channel 54 that is configured to receive the wire 16 therethrough and secure or lock the position of the wire 16 relative to the tooth bonding pad 52. To this end, the channel 54 is formed by a base 70 and lateral members 72, 74, which respectively define walls 70a, 72a, and 74a of the channel 54. The spacing between walls 70a, 72a, and 74a is suitably chosen to restrict or hinder movement of the wire 16 relative to the tooth bonding pad 52 in directions transverse to the longitudinal axis 54a.

The channel 54 is partially defined by a cover 80 that is coupled to base 70 and lateral members 72, 74 (jointly defining a main portion of the ligating structure 53) to thereby close the channel 54 about the wire 16. In this regard, as shown in FIG. 5, closure of the channel 54 restricts the tooth bonding pad 52 from movement in directions along and transverse to the longitudinal axis 54a. Accordingly, the ligating structure 53 takes the form of a self-ligating structure i.e., one that does not require additional modifications or components in order to secure the wire 16 and restrict relative movement thereof.

With continued reference to FIGS. 4-6, cover 80 may be releasably coupled to the main portion of the channel 54, for example, by being slidable in the direction shown by arrows 86 or, alternatively, in a direction transverse to arrows 86. One or more locking features (not shown) on the cover 80 or the main portion may permit coupling of the position of cover 80 relative to the main portion. For example, and without limitation, such locking features may include adhesives or mechanical or chemical devices. Moreover, in this embodiment, each of the lateral members 72, 74 includes respective notches 72a, 74a to facilitate coupling of the cover 80 to the main portion of the ligating structure 53. When the cover 80 and main portion of the channel 54 are coupled, they jointly define a closed channel surrounding and securing the position of the tooth bonding pad 52 relative to the wire 16 (and vice versa). The size and shape of the resulting closed channel may be such that movement of the wire 16 within the channel is restricted or at least hindered, in a direction transverse to the longitudinal axis 54a. Additionally, the size and shape of the closed channel may be such that movement of the wire 16 relative to the tooth bonding pad 52 in a direction along longitudinal axis 54a is similarly restricted or at least hindered.

While the resulting channel is depicted as a completely closed channel, those of ordinary skill in the art will readily appreciate that, alternatively, the channel may be other than completely closed. For example, and without limitation, the resulting channel may be merely substantially closed i.e., such that the wire 16 is restricted from movement as described above in regard to the completely closed channel of the embodiment of FIG. 5.

With reference to the embodiments of any of FIGS. 1-6, while the embodiments depicted therein show a wire 16 completely extending through the exemplary channels 48, 54, it is contemplated that the wire 16 may alternatively extend only partially therethrough. For example, an embodiment may include only an end of tip of the corrective device being received within the channel 48, 64 so long as the corresponding tooth bonding pad (respectively 22 and 52) lockingly engages the wire 16 therein. Likewise, the channels 48, 54 are not limited to the geometric shapes depicted in any of the figures. Instead, they may have any shape defined by any combination of planar and/or arcuate surfaces.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A tooth bonding pad for orthodontic applications, comprising:
a main body; and
a ligating structure adjacent said main body and including a channel configured to receive a corrective device therein and to restrict the corrective device from movement relative to said tooth bonding pad.

2. The tooth bonding pad of claim 1, wherein said ligating structure is crimpable.

3. The tooth bonding pad of claim 1, wherein said channel is a substantially closed channel.

4. The tooth bonding pad of claim 1, further comprising a cover configured to be coupled to portions of said ligating structure, said cover partially defining said channel.

5. The tooth bonding pad of claim 1, wherein said ligating structure is a self-ligating structure.

6. The tooth bonding pad of claim 1, wherein said channel defines a longitudinal axis, said ligating structure being configured to restrict movement of the corrective device in a direction along said longitudinal axis.

7. The tooth bonding pad of claim 1, wherein said channel defines a longitudinal axis, said ligating structure being configured to restrict movement of the corrective device in a direction transverse to said longitudinal axis.

8. An orthodontic assembly comprising:
a corrective device having an elongate portion; and
a tooth bonding pad configured for coupling to a tooth and including a channel configured to receive said elongate portion therein and to restrict said corrective device from movement relative to said tooth bonding pad.

9. The orthodontic assembly of claim 8, wherein said corrective device is one of a group consisting of wires and springs.

10. The orthodontic assembly of claim 8, wherein said ligating structure is crimpable.

11. The orthodontic assembly of claim 8, wherein said ligating structure includes a main portion and a cover configured for coupling with said main portion, coupling of said cover to said main portion defining said channel.

12. The orthodontic assembly of claim 11, wherein said channel defines a longitudinal axis, coupling of said cover to said main portion restricting movement of said corrective device relative to said tooth bonding pad in a direction along said longitudinal axis.

13. An orthodontic assembly, comprising:
an orthodontic implant;
a corrective device having an elongate portion and being coupled to said orthodontic implant; and
a tooth bonding pad configured for coupling to a tooth and including a channel configured to receive said elongate portion therein and to restrict said corrective device from movement relative to said tooth bonding pad.

14. The orthodontic assembly of claim 13, wherein said orthodontic implant is a screw.

15. The orthodontic assembly of claim 13, wherein said corrective device is one of a group consisting of wires and springs.

16. The orthodontic assembly of claim 13, wherein said channel defines a longitudinal axis and is configured to restrict movement of said corrective device relative to said tooth bonding pad in a direction along said longitudinal axis.

17. The orthodontic assembly of claim 13, wherein said channel defines a longitudinal axis and is configured to restrict movement of said corrective device relative to said tooth bonding pad in a direction transverse to said longitudinal axis.

18. A tooth bonding pad for orthodontic applications, comprising:
a main body; and
a ligating structure adjacent said main body and including a channel defining a longitudinal axis and configured to receive a corrective device therein and to restrict the corrective device from movement relative to said tooth bonding pad in a direction along said longitudinal axis and in a direction transverse to said longitudinal axis.

19. A method of coupling an orthodontic corrective device to a tooth, comprising:
coupling a tooth bonding pad to the tooth;
inserting an elongate portion of the corrective device through a channel in the tooth bonding pad; and
closing the channel around the corrective device to thereby restrict the corrective device relative to the tooth bonding pad.

20. The method of claim 19 further comprising restricting the corrective device from movement in a direction along an axis of the channel.

21. The method of claim 19 further comprising restricting the corrective device from movement in a direction transverse to an axis of the channel.

22. The method of claim 19 further comprising crimping a portion of the tooth bonding pad to thereby lockingly engage the tooth bonding pad and the corrective device relative to one another.

23. The method of claim 19, wherein inserting an elongate portion of the corrective device includes inserting a wire through the channel.

24. The method of claim 20, wherein closing the channel includes coupling a cover of the tooth bonding pad with other portions thereof to thereby define the channel.

25. The method of claim 24, wherein coupling the cover includes slidably coupling the cover with other portions of the tooth bonding pad.
